(19) United States
(12) Patent Application Publication
(10) Pub. No.: US 2016/0122927 A1
(43) Pub. Date: May 5, 2016

(54) Method to Joint 3-Dimensional Woven Material

(71) Applicant: Nhung T. Brown, Saugus, MA (US)

(72) Inventor: Nhung T. Brown, Saugus, MA (US)

(21) Appl. No.: 14/528,681

(22) Filed: Oct. 30, 2014

(51) Int. Cl. D05B 1/02; D05B 95/00; D05B 97/00; B32B 7/08

(52) U.S. Cl. CPC D05B 1/02; B32B 7/08; D05B 95/00; D05B 97/00

(57) ABSTRACT

The present invention provides techniques for binding 3D woven materials even over an inch thick using only materials found within the weave itself providing the advantages of a mechanically enhanced seam while avoiding the disadvantages associated with traditional techniques such as adhesives, fasteners, and uneven heat resistance. It further minimizes damage to the material used in the joining process and prevents the introduction of additional substances that would cause impurities in the resin process.

### TECHNICAL FIELD

Embodiments of the present invention relate generally to the manufacturing process, and more specifically to the manufacturing process involving binding 3D woven materials an inch thick and over.

### BACKGROUND

Current 3D fabric technologies place the various fibers in an optimized 3D configuration. The woven process results in panels 6″ to 24″ from 1″ to 3″ depending on the application. A traditional manufacturing and assembly approach would then infuse woven preforms with a resin, machine it to shape, and assemble as a tiled solution with an adhesive to fill the gaps between tiles. Such an adhesively bonded seam approach has significant challenges, not the least of which is the reduction in thermal-mechanical performance compared to that of the acreage woven material.

A mechanically enhanced seam inserted into the assembly process either before or after resin infusion would offer many advantages compared to the traditional adhesively bonded approach.

This leads to other issues, however: carbon fiber tow is easily broken when bent and gets fuzzy when it comes into contact with guide bars, needle eyes, and other metal parts; there is a limitation with current market industrial sewing machines being unable to sew materials thicker than 1 inch; normal stitching using traditional industrial machines uses two threads (top and bottom) to hold two panel materials, and the location where the top thread and bottom thread loop creates a very sharp turn of thread that will break carbon fiber tow; treatment options for tow are limited due the heat resistance incompatibility between the two materials; there is frequently the strict requirement to join these tiles only using the same materials as the tiles use themselves without any additional chemicals as the additional chemicals would provide an unacceptable impurity to the resin process later.

### SUMMARY

The present invention consists of a general method of binding that avoids all the problems described in [0004]. It consists of pre-holing the panels, lining them up on top of one another, feeding tow through them both loosely to ensure thread angles are obtuse, pulling both ends of the tow to uniformly tighten the join, and rotating one panel relative to the other to bring them both into the same plane. The present invention further provides specific techniques to enable butt stitches, angle-angle stitches, and angle-normal stitches.

The present invention eliminates adhesives that would melt and not hold well at high heat.

The present invention eliminates fasteners. Fasteners are made from other materials than that which needs to be joined, creating uneven heat resistance. They require lap cuts, with limited tool options to perform the task.

The present invention eliminates Z pins. These can be performed at side but otherwise have problems similar to those of fasteners.

The present invention eliminates complex joins like piano hinges, self locking, reinforcement slats, and T-joints. These joints could not hold the material by themselves when the object is in movement.

The present invention eliminates stitch lap joints which have the limitation of requiring lap cuts.

The present invention completely avoids uneven heat resistance by making a mechanically enhanced seam using the same materials that compose the panels being joined. The novel stitching technique of paragraph [0005] prevents the majority of tow breakage that normally makes this general approach impractical.

### BRIEF DESCRIPTION OF THE DRAWINGS

FIG. 1 illustrates the lining up of pre-holes and the arrangement of tow for both normal cut and angle cut panels.

FIG. 2 illustrates two needle handling techniques to feed tow through pre-holes while minimizing significant thread damage and breakage.

FIG. 3 illustrates the run of tow through the materials being joined in detail.

### DETAILED DESCRIPTION

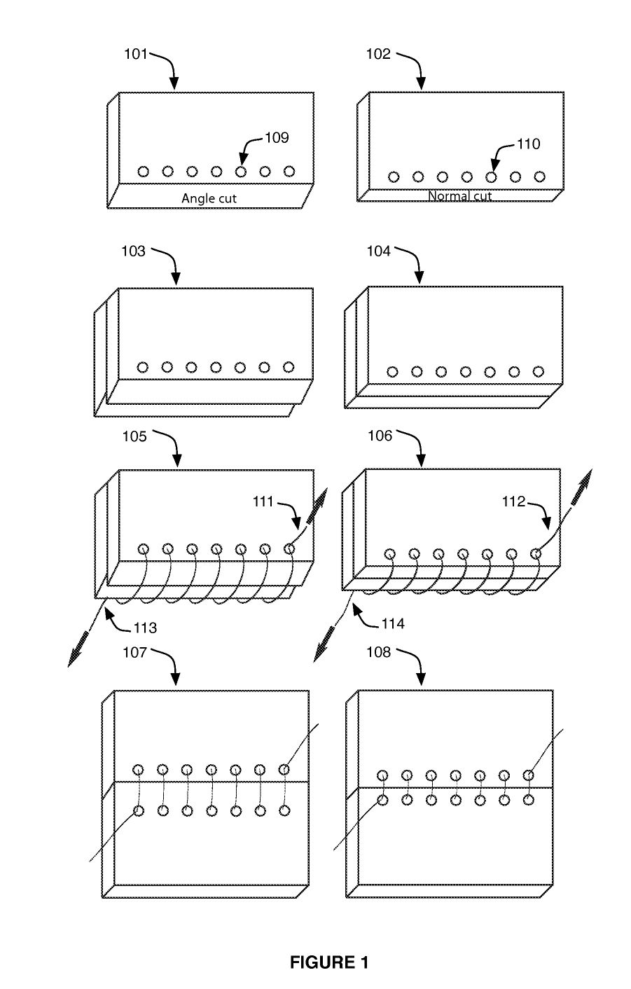

FIG. 1 illustrates a method of binding normal cut or angle cut panels of 3D woven materials using fibers of the same material for tow. For normal cut panels the panels must first be pre-holed as in 101 (the pre-holes themselves are depicted by 109) and then lined up on top of one another as in 103. Next the one or more tow must be fed through both panels loosely, carefully keeping tow angles obtuse to prevent breaks, and both ends (111 and 113) must be pulled uniformly to tighten the join as in 105. Finally rotating one normal cut panel relative to the other will bring them both into the same plane as shown in 107. The procedure for angle cut panels is similar. The panels must first be pre-holed as in 102 (the pre-holes themselves are depicted by 110) and then lined up on top of one another aligning the holes as in 104. Next the one or more tow must be fed through both panels loosely, carefully keeping thread angles obtuse to prevent breaks, and both ends (112 and 114) must be pulled uniformly to tighten the join as in 106. Finally, rotating one angle cut panel relative to the other will bring them both into the same plane as shown in 108. This technique can be generalized to different combinations of normal cut, angle cut, and butt joins.

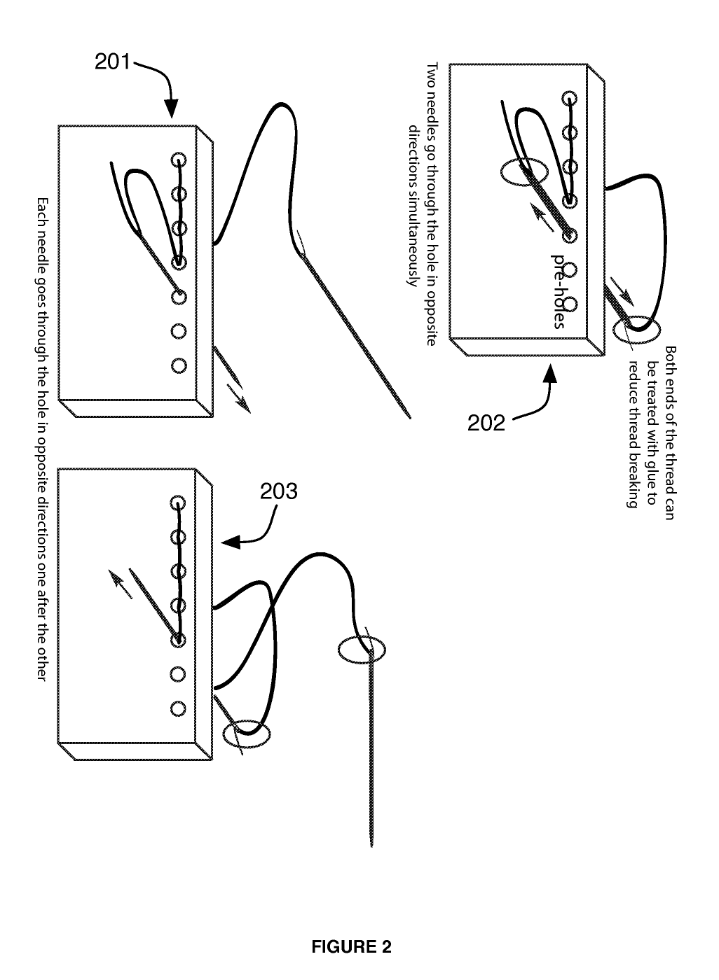

FIG. 2 illustrates two methods of using a needle to get the fiber tow through the pre-holes of the panels. The simultaneous method shown in 202 ensures that needle tips will only encounter the other needle in the pre-hole, preventing damage to the tow. The synchronous method of feeding one needle through (201) before the other (203) requires more skill on the part of the operator to avoid damage. In either case the ends of the fiber tow may be treated with a material like glue to help keep them from fraying and breaking. As the ends will be completely pulled through the panels, this treating substance will not add any impurities to the resin process.

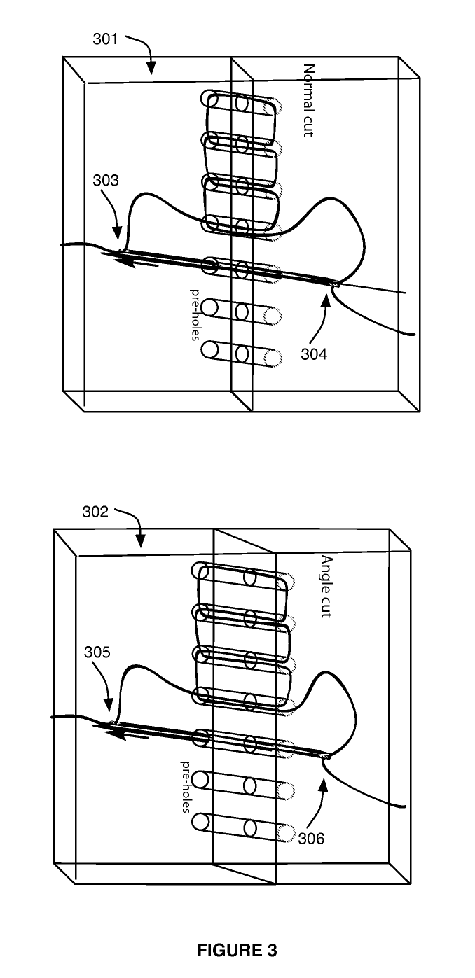

FIG. 3 illustrates the run of the tow through panels. The run through normal cut panels is shown by 301 with 303 and 304 showing the left and right needles respectively. The run of tow through angle cut panels is shown by 304 with 305 and 306 showing the left and right needles respectively. This result can even be achieved by hand without the initial alignment and final rotation.

While the present invention defines a technique completely different from what existing sewing machines are capable of doing, it is understood that machines may be developed that will rely on it, and details like the simultaneous needle handling method described in [0016] will make future automation easier.

What is claimed is:

1. A method of joining two or more pieces of woven 3D material requiring only materials found within the base 3D material itself, where limitations of the fiber tow are overcome by pre-holing the material being sewn and maintaining obtuse tow angles while sewing.

2. The method of claim 1, wherein the materials being used include carbon fiber.

3. The method of claim 1, wherein the materials being used include synthetic fibers like Kevlar, Twaron, Nomex, Technora, Aramid, Innegra, Vectra, or Vectran.

4. The method of claim 1, wherein the materials being used include glass fiber.

5. The method of claim 1, wherein thread or yarn is used in lieu of tow.

6. The method of claim 1, further comprising the two strands being stitched simultaneously in opposite directions through the material.

7. The method of claim 1, further comprising the two strands being stitched synchronously one after the other in opposite directions through the material.

8. The method of claim 1, further comprising the lining up of pre-holes in the materials being joined one atop the other, feeding the tow through them both loosely, pulling both ends of the tow, and rotating one panel relative to the other.

9. The method of claim 1, further comprising the materials being lined up in their final position prior to feeding the tow through them both loosely and pulling both ends of the tow.

10. The method of claim 1, wherein some of the materials being joined are normal cut.

11. The method of claim 1, wherein some of the materials being joined are angle cut.

12. The method of claim 1, wherein the join is a butt join.

13. The method of claim 1, wherein the fiber tow are treated with another substance to make sewing easier.

14. The method of claim 1, wherein the work is done by hand.

15. The method of claim 1, wherein the work is done by machine.
